(19) United States
(12) Patent Application Publication
(10) Pub. No.: US 2012/0098372 A1
(43) Pub. Date: Apr. 26, 2012

(54) ROTARY ELECTRIC MACHINE AND ROTOR THEREFOR

(75) Inventor: Yuji SAJIKAWA, Fukuoka (JP)

(73) Assignee: KABUSHIKI KAISHA YASKAWA DENKI, Kitakyushu-shi (JP)

(21) Appl. No.: 13/238,445

(22) Filed: Sep. 21, 2011

(30) Foreign Application Priority Data
Oct. 25, 2010 (JP) 2010-238937

(51) Int. Cl. H02K 1/27; H02K 5/00; H02K 21/12

(52) U.S. Cl. 310/91; 310/152

(57) ABSTRACT

A rotor includes a rotor core and a plurality of permanent magnets aligned in a circumferential direction of the rotor core. An inner circumferential surface of the rotor core includes a first portion formed at a position corresponding to a central portion of the permanent magnet in a circumferential direction, the first portion being recessed with respect to a second portion corresponding to a boundary between circumferentially adjacent permanent magnets.

### CROSS-REFERENCE TO RELATED APPLICATIONS

The present application claims priority under 35 U.S.C. §119 to Japanese Patent Application No. 2010-238937 filed Oct. 25, 2010. The contents of this application are incorporated herein by reference in their entirety.

### BACKGROUND OF THE INVENTION

1. Field of the Invention

The present invention relates to a rotor and a rotary electric machine.

2. Discussion of the Background

Rotary electric machines that can be used as an electric motor and a power generator include a permanent magnet type rotary electric machine. The permanent magnet type rotary electric machine includes a rotor having a plurality of permanent magnets aligned in a circumferential direction of a rotor core, and a stator disposed so as to oppose the outer circumferential surface of the rotor with a gap therebetween.

Such rotary electric machines are achieving a higher output along with a reduction in size and weight, owing to an increase in density of residual magnetic flux of the permanent magnets. Therefore, the permanent magnet type rotary electric machines have now come to be employed in various fields. Examples of such permanent magnet type rotary electric machines include a permanent magnet synchronous motor, which is widely employed in the fields of machine tools, electric vehicles, robots and so forth, for example as disclosed in Japanese Unexamined Patent Application Publication No. 2002-281721.

### SUMMARY OF THE INVENTION

According to one aspect of the present invention, a rotor for a rotary electric machine is provided that includes a cylindrical-shaped rotor core, and a plurality of permanent magnets aligned in a circumferential direction of the rotor core, and a portion of an inner circumferential surface of the rotor core corresponding to a central portion of the permanent magnet in the circumferential direction is recessed with respect to a portion of the inner circumferential surface corresponding to a boundary between circumferentially adjacent ones of the permanent magnets.

According to another aspect of the present invention, a rotary electric machine is provided that includes a rotor including a cylindrical-shaped rotor core and a plurality of permanent magnets aligned in a circumferential direction of the rotor core, and a stator disposed so as to oppose an outer circumferential surface of the rotor with a gap therebetween, and a portion of an inner circumferential surface of the rotor core corresponding to a central portion of the permanent magnet in the circumferential direction is recessed with respect to a portion of the inner circumferential surface of the rotor core corresponding to a boundary between circumferentially adjacent ones of the permanent magnets.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A is a transverse cross-sectional view of a rotary electric machine according to a first embodiment;

FIG. 1B is an enlarged view of a portion indicated by H in FIG. 1A;

FIG. 2 is a vertical cross-sectional view of the rotary electric machine according to the first embodiment;

FIG. 3 is another transverse cross-sectional view of the rotary electric machine according to the first embodiment;

FIG. 4 is an enlarged view of a portion indicated by H in FIG. 3;

FIG. 5 is a cross-sectional view showing a status of a magnetic flux of a rotor core having a circular inner circumferential surface;

FIG. 6 is a cross-sectional view showing a status of a magnetic flux of the rotor core shown in FIG. 4;

FIG. 7 is an enlarged fragmentary transverse cross-sectional view of a rotary electric machine according to a second embodiment;

FIG. 8 is an enlarged fragmentary transverse cross-sectional view of a rotary electric machine according to a third embodiment;

FIG. 9 is an enlarged fragmentary transverse cross-sectional view of a rotary electric machine according to a fourth embodiment;

FIG. 10 is an enlarged fragmentary transverse cross-sectional view of a rotary electric machine according to a fifth embodiment;

FIG. 11 is an enlarged fragmentary transverse cross-sectional view of a rotary electric machine according to a sixth embodiment; and

FIG. 12 is an enlarged fragmentary transverse cross-sectional view of a rotary electric machine according to a seventh embodiment.

### DESCRIPTION OF THE EMBODIMENTS

Embodiments will now be described with reference to the accompanying drawings, wherein like reference numerals designate corresponding or identical elements throughout the various drawings. It is to be understood that the present invention is in no way limited to the following embodiments.

### First Embodiment

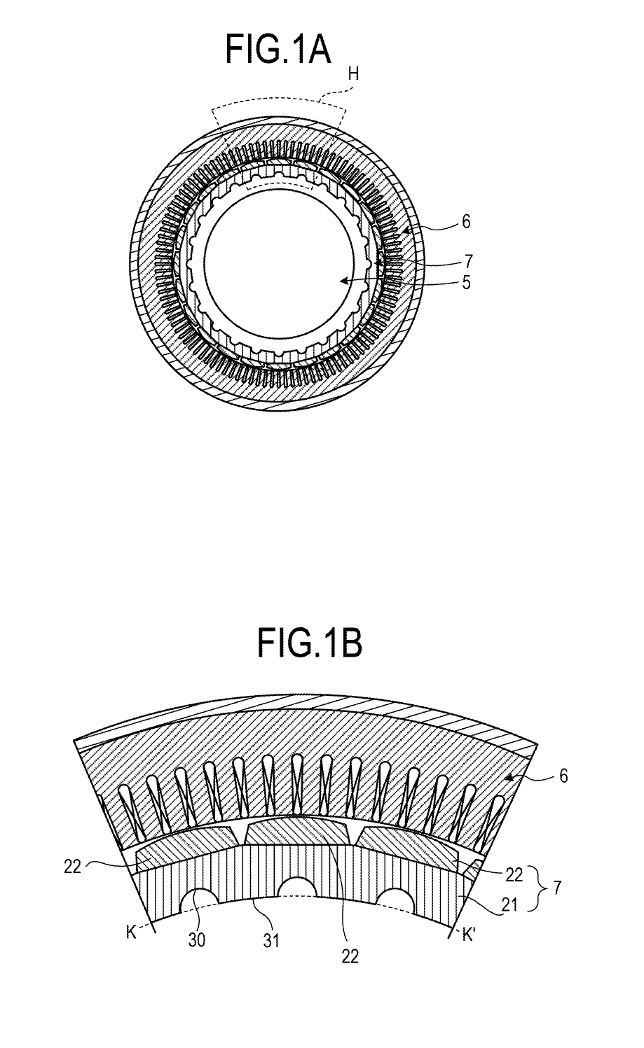

A rotor of a rotary electric machine according to a first embodiment will be described referring to FIGS. 1A and 1B. FIG. 1A is a transverse cross-sectional view of a rotary electric machine according to the embodiment, and FIG. 1B is an enlarged view of a portion indicated by H in FIG. 1A. The rotary electric machine can be exemplified by an electric motor and a power generator. The direction in which a shaft (to be described later) extends corresponds to a longitudinal direction of the rotary electric machine.

As shown in FIG. 1A, the rotary electric machine according to this embodiment includes a shaft 5, a stator 6, and a rotor 7. The stator 6 is disposed so as to oppose the outer circumferential surface of the rotor 7 with a predetermined gap therebetween, and the rotor 7 is attached to the shaft 5.

The rotor 7 includes a rotor core 21 and permanent magnets 22 as shown in FIG. 1B. The rotor core 21 is formed in a cylindrical shape, and the permanent magnets 22 are aligned in a circumferential direction on the outer circumferential surface at a predetermined interval.

In the case where the rotary electric machine is employed as an electric motor, upon supplying a current to a stator winding of the stator 6 a revolving magnetic field is generated inside the stator 6. Then the rotor is caused to rotate by an interaction of the revolving magnetic field and a magnetic field generated by the permanent magnets 22 of the rotor 7, and the shaft 5 is made to rotate along with the rotation of the rotor 7. In contrast, in the case where the rotary electric machine is employed as a power generator, an operation inverse to that of the electric motor is performed. Specifically, a rotation of the shaft 5 causes the rotor 7 to rotate, so that a current is generated on the stator winding of the stator 6.

In the rotor 7 according to this embodiment, the rotor core 21 includes a plurality of recesses formed on an inner circumferential surface thereof at positions where a magnetic flux of the permanent magnet 22 has a relatively low density, rather than having a circular inner circumferential surface, for example as indicated by a line K-K′ in FIG. 1B. In other words, as shown in FIG. 1B, the inner circumferential surface of the rotor core 21 includes a first portion 30 formed at positions corresponding to a central portion of the respective permanent magnets 22 in a circumferential direction, the first portion 30 being recessed with respect to a second portion 31 corresponding to a boundary between the circumferentially adjacent permanent magnets 22.

Forming thus the recesses in a radially outward direction on the inner circumferential surface of the rotor core 21 makes the rotor core 21 partially thinner, compared with forming the entire inner circumferential surface in a circular shape. Such a configuration allows a reduction in weight of the rotor core 21, which leads to a reduction in weight of the rotor 7 as a whole. Further, the reduction in weight of the rotor 7 results in a reduced moment of inertia of the rotor 7. Consequently, the characteristic of the rotary electric machine can be improved.

### Specific Structure of Rotary Electric Machine

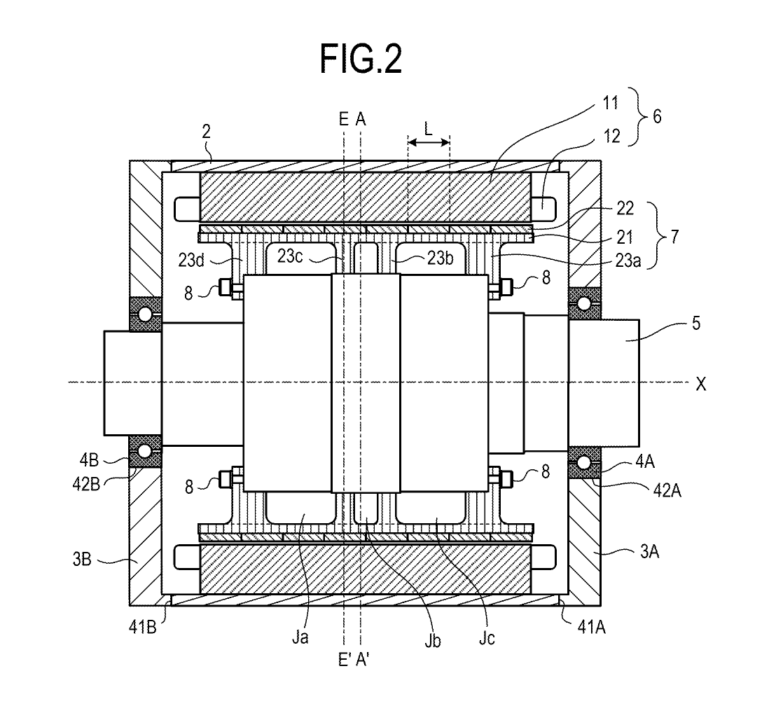

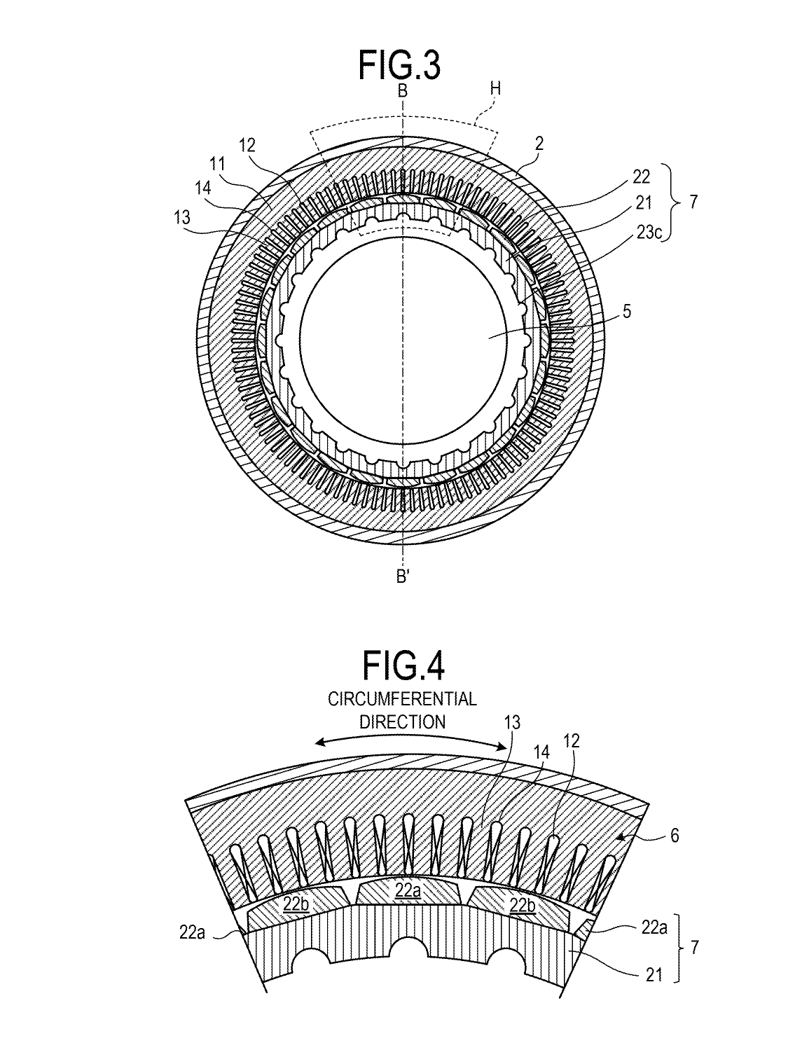

Hereunder, the structure of the rotary electric machine according to the first embodiment will be described in detail. FIG. 2 is a vertical cross-sectional view of the rotary electric machine according to the first embodiment, FIG. 3 is another transverse cross-sectional view of the rotary electric machine according to the first embodiment, and FIG. 4 is an enlarged view of a portion indicated by H in FIG. 3. Here, FIG. 2 corresponds to a cross-sectional view taken along a line B-B′ in FIG. 3, and FIG. 3 corresponds to a cross-sectional view taken along a line A-A′ in FIG. 2.

As shown in FIG. 2, the rotary electric machine according to the first embodiment includes a frame 2, brackets 3A, 3B, bearings 4A, 4B, the shaft 5, the stator 6 and the rotor 7.

The frame 2 has a cylindrical shape, to the inner circumferential surface of which the outer circumferential surface of the stator 6 is fixed. The bracket 3A has a generally disk shape, and an outer circumferential portion 41A thereof is attached to an opening edge of the frame 2, and an inner circumferential portion 42A serves to retain the bearing 4A. Likewise, the bracket 3B has a generally disk shape, and an outer circumferential portion 41B thereof is attached to the other opening edge of the frame 2, and an inner circumferential portion 42B serves to retain the bearing 4B.

The shaft 5 is positioned such that its center coincides with a central axis X of the frame 2, and supported by the bearings 4A, 4B so as to rotate about the central axis X. The stator 6 includes a stator core 11 and a stator winding 12, and the rotor 7 is disposed so as to oppose the inner circumferential portion of the stator 6 with a gap therebetween.

The stator core 11 is formed of a multitude of thin plates such as magnetic steel sheets stacked on one another. The stator core 11 includes a multitude of teeth 13 formed on the inner circumferential side thereof, as shown in FIGS. 3 and 4. A space between the teeth 13 is called a slot 14. The inner circumferential surface of the slot 14 is covered with an insulative material, and a stator winding 12 formed of a distributed winding of a shielded wire is accommodated in the slot 14. Here, the stator winding 12 may be formed of a concentrated winding.

As shown in FIG. 2, the rotor 7 includes the rotor core 21, the plurality of permanent magnets 22, and support brackets 23a to 23d, and is set to rotate about the center of the shaft 5, which coincides with the central axis X.

The rotor core 21 is formed of a multitude of thin plates such as magnetic steel sheets stacked on one another, so as to suppress an eddy current. The rotor core 21 has a cylindrical shape, and serves to transmit the magnetic flux of the permanent magnets 22. The configuration of the rotor core 21 will be subsequently described in further detail.

The permanent magnets 22 are aligned on the outer circumferential surface of the rotor core 21. The permanent magnets 22 include permanent magnets 22a, 22b of different polarities, as shown in FIG. 4. The permanent magnet 22a has an S-pole on its surface contacting the rotor core 21 and an N-pole on the opposite surface. The permanent magnet 22b has an N-pole on its surface contacting the rotor core 21 and an S-pole on the opposite surface.

As shown in FIG. 2, the permanent magnets 22 of the same polarity are aligned in a longitudinal direction of the shaft 5, on the outer circumferential surface of the rotor core 21. In the circumferential direction of the rotor core 21, the permanent magnets 22a, 22b of different polarities are alternately aligned, as shown in FIG. 4.

The support brackets 23a to 23d are integrally formed with the rotor core 21 as shown in FIG. 2, by stacking a multitude of thin plates such as magnetic steel sheets. The support brackets 23a to 23d have a ring shape projecting from the inner circumferential surface of the cylindrical rotor core 21 toward the shaft 5. The rotor core 21 and the support brackets 23a to 23d may be integrally formed of a magnetic-permeable material such as iron, instead of stacked magnetic steel sheets. Methods of integral formation include casting and machining.

The support brackets 23a to 23d are fixed to the shaft 5, by attaching thereto the support brackets 23a, 23d with a plurality of bolts 8, with the inner circumferential surface of the support brackets 23a to 23d abutted to the outer circumferential surface of the shaft 5. Thus, the rotor core 21 is rotatably supported on the shaft 5 by the support brackets 23a to 23d.

### Configuration of Rotor Core 21

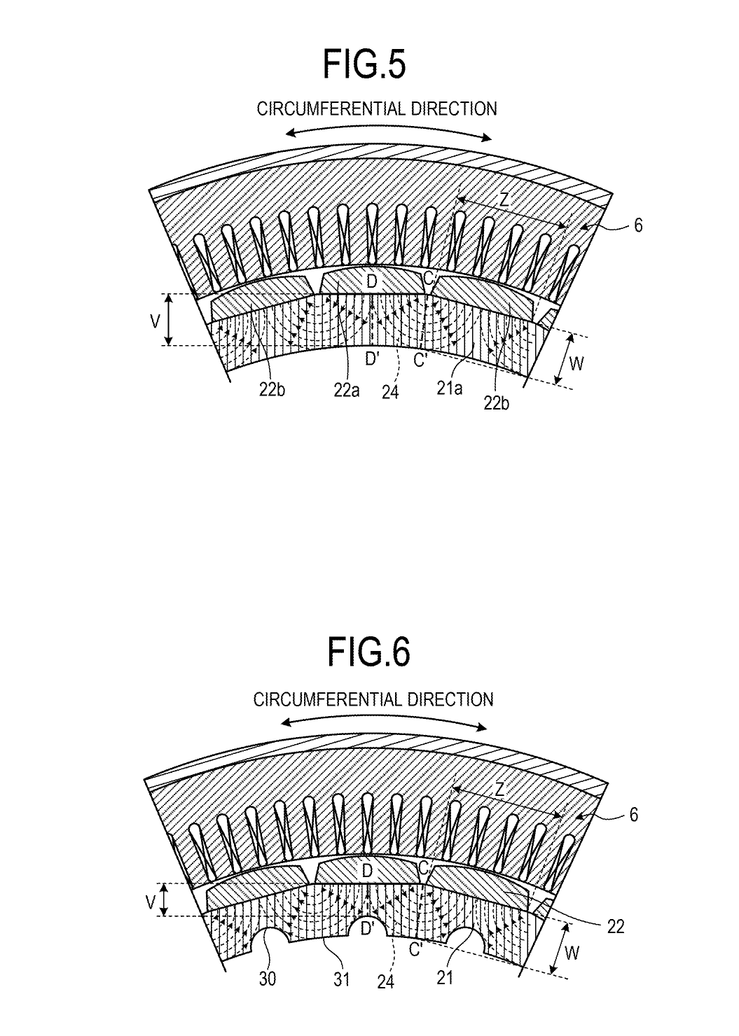

In the rotor 7 of the rotary electric machine according to this embodiment, the rotor core 21 has such a form that can reduce the weight of the rotor 7 as already stated. Referring now to FIGS. 5 and 6, the configuration of the rotor core 21 will be described in further detail. The stator 6 and the permanent magnets 22 shown in FIGS. 5 and 6 are the same in shape and location as those shown in FIGS. 3 and 4.

First, a status of a magnetic flux of a rotor core having a circular inner circumferential surface will be described. FIG. 5 depicts a status of the magnetic flux of a rotor core 21a having a circular inner circumferential surface. As shown therein, the magnetic flux in the rotor core 21a from the permanent magnets 22 constitutes a magnetic flux 24 flowing between the adjacent permanent magnets 22a, 22b of different polarities.

The magnetic flux 24 has a largest amount (hereinafter, magnetic flux amount) in a region C-C′ between a center of adjacent permanent magnets 22a, 22b of different polarities and the inner circumferential surface of the rotor core 21a, and a smallest amount in a region D-D′ between a center of each permanent magnet 22 in the circumferential direction and the inner circumferential surface of the rotor core 21a. In other words, magnetic flux density is higher in the region C-C′ and lower in the region D-D′.

In the region D-D′ where the magnetic flux density is low, although the magnetic flux 24 is present in a region close to the permanent magnet 22, the magnetic flux 24 is barely present in a region away from the permanent magnet 22, as shown in FIG. 5. Accordingly, reducing a thickness V of the region D-D′ where the magnetic flux density is low with respect to a thickness W of the region C-C′ barely affects the characteristic of the rotor 7.

Thus, inner circumferential surface of the rotor core 21 shown in FIG. 6 includes the first portion 30 formed by reducing the thickness V of the region D-D′ where the density of the magnetic flux 24 from the permanent magnet 22 is low, and the second portion 31 having a greater thickness W formed in the region C-C′ where the density of the magnetic flux 24 from the permanent magnet 22 is relatively high. In other words, the first portion 30 corresponding to the center of the permanent magnet 22 in the circumferential direction is recessed with respect to the second portion 31 corresponding to a boundary between the circumferentially adjacent permanent magnets 22.

The first portion 30 and the second portion 31 are successively and alternately formed in the circumferential direction. Accordingly, the same number of first portions 30 as the number of permanent magnets 22 are formed in a recessed shape on the inner circumferential surface of the rotor core 21, and a weight corresponding to the recess multiplied by the number of permanent magnets 22 is reduced, resulting in weight reduction of the rotor core 21.

Further, since the rotor core 21 is a radially outer portion of the rotor 7 and the recessed first portions 30 are provided at regular intervals on the inner circumferential surface of the rotor core 21, the moment of inertia of the rotor 7 can be effectively reduced.

The thickness W of the region C-C′ where the magnetic flux density is high can be determined as described below. For easier understanding, permeance coefficient of the permanent magnet 22 will not be taken into account.

Upon excluding the permeance coefficient of the permanent magnet 22, the amount of the magnetic flux 24 flowing from the permanent magnet 22 into the rotor core 21 is uniform throughout the contact interface between the permanent magnet 22 and the rotor core 21.

Accordingly, upon assuming an axial length L of the permanent magnet 22 (see FIG. 2) as “1”, the amount of magnetic flux Φ (Wb) flowing from the surface of the permanent magnet 22 into the rotor core 21 can be obtained from a maximum energy product BH (GOe) of the permanent magnet 22, as expressed in the following equation (1):

Φ=0.2×√(BH) (1)

For example, in the case of employing a permanent magnet having a BH of 42 (MGOe) as the permanent magnet 22, the magnetic flux amount Φ flowing from the surface of the permanent magnet 22 into the rotor core 21 becomes 1.296 (Wb) according to the equation (1), and such a magnetic flux amount Φ flows out from the permanent magnet 22 over a width Z thereof (see FIG. 6).

The flow of the magnetic flux 24 from the permanent magnet 22 is split to the respective sides of the center of the permanent magnet 22 in the circumferential direction, as shown in FIG. 6. Thus, the magnetic flux density of the region C-C′ where the magnetic flux density is highest becomes 1.296 (T) in the case where a half of the width Z of the permanent magnet 22 and the thickness W of the region C-C′ are equal.

To determine the thickness W of the region C-C′, an impact on the characteristic of the rotor core 21 has to be taken into account. In the case where the magnetic flux density of the region C-C′ is set to be equal to or lower than 1.3 (T), the thickness W of the region C-C′ has to be increased, although the characteristic is not affected. Accordingly, reduction in weight and moment of inertia cannot be effectively achieved.

Conversely, in the case where the thickness W of the region C-C′ is reduced so that the magnetic flux density of the region C-C′ becomes equal to or higher than 2.3 (T), the rotor core 21 is completely saturated with the magnetic flux. Such a situation provokes, in the case where the rotary electric machine is employed as an electric motor for example, what is known as torque saturation where an output torque cannot be increased despite increasing the current on the stator winding 12.

In view of the foregoing, it is preferable that the magnetic flux density is set in a range of 1.3 (T) to 2.3 (T) in the region C-C′ where the magnetic flux density is highest. It is preferable, therefore, to determine the thickness W of the region C-C′ such that the magnetic flux density remains in the range of 1.3 (T) to 2.3 (T), for forming the second portion 31.

In order to set the magnetic flux density of the region C-C′ in the range of 1.3 (T) to 2.3 (T), the thickness W of the region C-C′ can be obtained from the following equation (2):

1.3≦0.2×√(BH)/W×Z/2≦2.3 (2)

Accordingly, the range of the thickness W of the region C-C′ can be obtained from the equation (2) in the case where the BH of the permanent magnet 22 and the width Z are known. For example, on the assumption that the BH of the permanent magnet 22 is 42 (MGOe) and the width Z is 20, the thickness W can be worked out as 5.64≦W≦9.97 from the equation (2).

As described above, the inner circumferential surface of the rotor core 21 according to the first embodiment includes the first portion 30 corresponding to the region where the density of the magnetic flux 24 from the permanent magnet 22 is relatively low, the first portion 30 being recessed radially outward with respect to the second portion 31 corresponding to the region where the density of the magnetic flux 24 from the permanent magnet 22 is relatively high. Also, the second portion 31 is formed such that the magnetic flux density of the region C-C′ remains in the range of 1.3 (T) to 2.3 (T).

Forming thus the inner circumferential surface of the rotor core 21 allows a reduction in weight of the rotor core 21, which leads to a reduction in weight of the rotor 7 as a whole. Further, the reduction in weight of the rotor 7 results in a reduced moment of inertia of the rotor 7.

### Second Embodiment

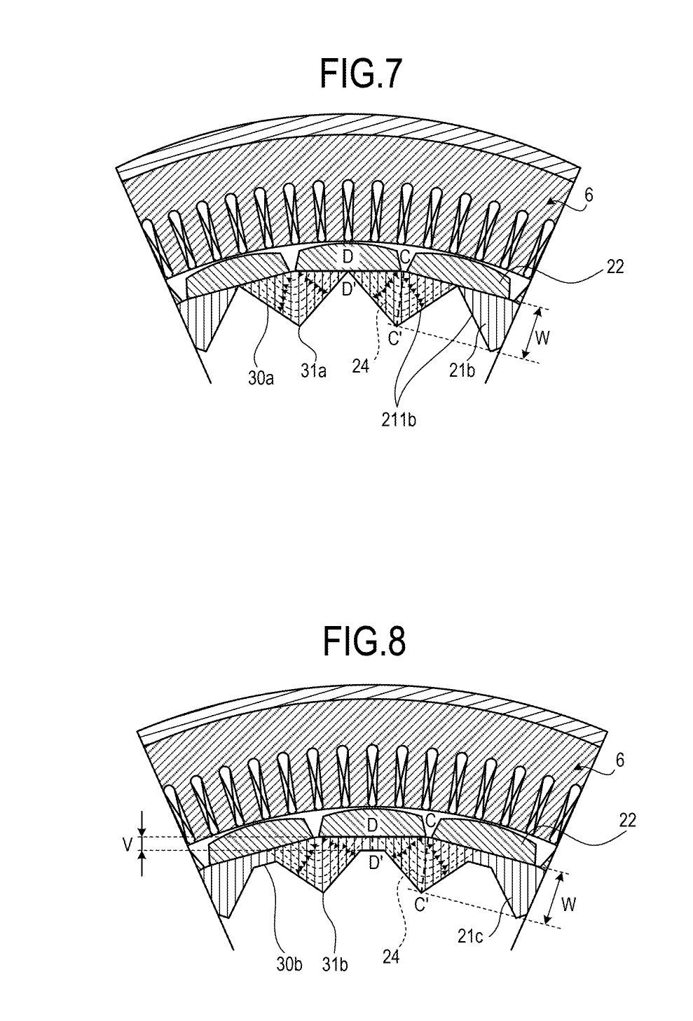

Referring now to FIG. 7, a rotary electric machine according to a second embodiment will be described. FIG. 7 is an enlarged fragmentary transverse cross-sectional view of the rotary electric machine according to the second embodiment. The rotary electric machine according to this embodiment is different from that of the first embodiment in shape of the inner circumferential surface of the rotor core.

As stated with reference to the first embodiment, it is preferable to determine, in the rotor core, the thickness W of the region C-C′ where the magnetic flux density is highest such that the magnetic flux density in the region C-C′ remains in the range of 1.3 (T) to 2.3 (T), to thereby reduce the weight of the rotor core.

In contrast, the thickness V of the region D-D′ where the magnetic flux density is low in the rotor core can be made zero. Therefore, FIG. 7 shows an ideal shape of the inner circumferential surface of the rotor core from the viewpoint of the magnetic flux density for achieving a weight reduction, in which the thickness V of the region D-D′ where the magnetic flux density is low is zero, and a first portion 30a is formed by linearly connecting a point D and a point C′, the point C′ constituting a second portion 31a.

The rotary electric machine according to the second embodiment adopts, therefore, a rotor core 21b shown in FIG. 7 as the rotor core of the rotor 7. The rotor core 21b is divided into a plurality of divisions 211b. The divisions 211b are supported by the support brackets 23a to 23d so as to be aligned in a cylindrical shape. Such a configuration enables further weight reduction compared with the rotary electric machine according to the first embodiment, thereby achieving further weight reduction of the rotor core 7. With such further weight reduction of the rotor 7, the moment of inertia of the rotor 7 can also be further reduced.

### Third Embodiment

Referring now to FIG. 8, a rotary electric machine according to a third embodiment will be described. FIG. 8 is an enlarged fragmentary transverse cross-sectional view of the rotary electric machine according to the third embodiment. The rotary electric machine according to this embodiment is different from those of the first and the second embodiment in shape of the inner circumferential surface of the rotor core.

As stated with reference to the second embodiment, the thickness V of the region D-D′ where the magnetic flux density is low can be made zero. However, from the viewpoint of the mechanical strength of the rotor core, it is preferable to give a certain thickness V to the region D-D′.

The rotary electric machine according to the third embodiment adopts, therefore, a rotor core 21c shown in FIG. 8 as the rotor core of the rotor 7. More specifically, in the rotor core 21c of the rotor 7, the point C′ constitutes a second portion 31b, while the thickness V of the region D-D′ where the magnetic flux density is low is set in a range of 20% to 80% of the thickness W of the region C-C′, so that a first portion 30b is formed in an inverted trapezoidal shape.

Forming thus the rotor core 21c results in an increased mechanical strength of the rotor core, compared with the rotary electric machine according to the second embodiment.

### Fourth Embodiment

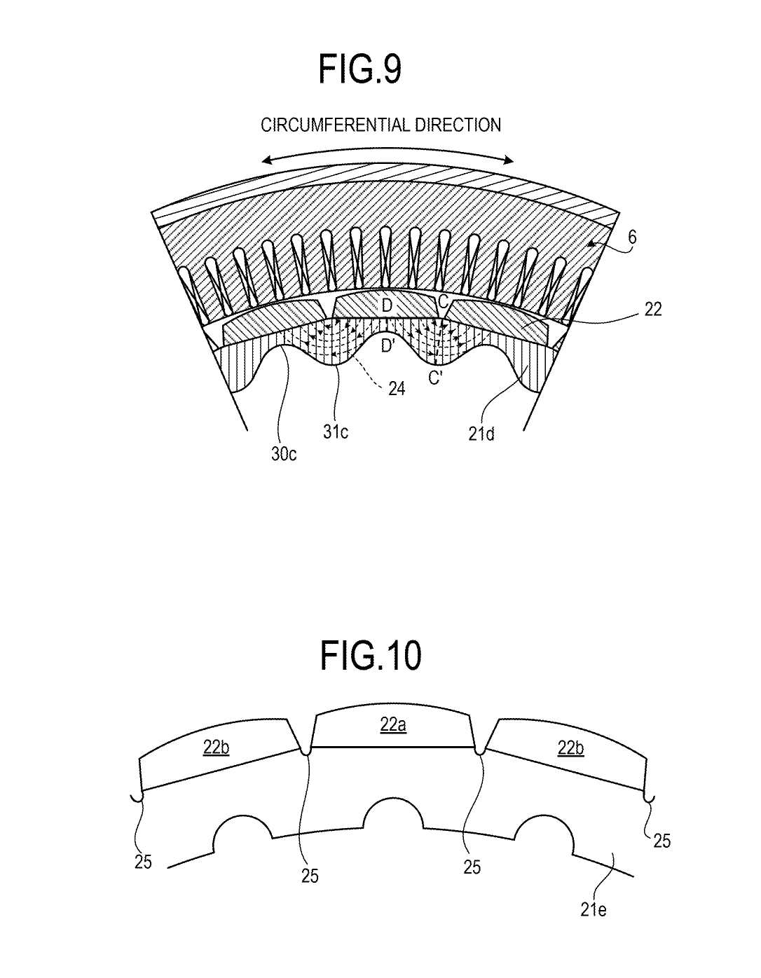

Referring now to FIG. 9, a rotary electric machine according to a fourth embodiment will be described. FIG. 9 is an enlarged fragmentary transverse cross-sectional view of the rotary electric machine according to the fourth embodiment. The rotary electric machine according to this embodiment is different from those of the first to the third embodiments in shape of the inner circumferential surface of the rotor core.

As shown in FIG. 9, the inner circumferential surface of a rotor core 21d of the rotary electric machine according to this fourth embodiment is formed in an arcuate shape from a first portion 30c corresponding to the central portion of the permanent magnet 22 in the circumferential direction to a second portion 31c corresponding to a boundary between the circumferentially adjacent permanent magnets 22.

The rotor core 21d is thus formed in a roundish, curved shape over the entire inner circumferential surface, and hence stress concentration can be mitigated and loss from stress concentration can be suppressed. In particular, forming the inner circumferential surface of the rotor core in a sine wave form as shown in FIG. 9 allows stress concentration to be more effectively mitigated.

Here, forming the rotor core 21 of the rotary electric machine according to the first embodiment in an arcuate shape with rounded corners between the first portion 30 and the second portion 31 allows stress concentration to be mitigated compared with the configuration shown in FIG. 6. Likewise, the rotor core 21b, 21c of the rotary electric machine according to the second and the third embodiment can be relieved from stress concentration by forming rounded corners.

### Fifth Embodiment

Referring now to FIG. 10, a rotary electric machine according to a fifth embodiment will be described. FIG. 10 is an enlarged fragmentary transverse cross-sectional view of the rotary electric machine according to the fifth embodiment. The rotary electric machine according to this embodiment is intended for a reduction in weight and moment of inertia of the rotor 7, in addition to the reduction in weight and moment of inertia thereof resulting from the shape of the inner circumferential surface of the rotor core according to the first to the fourth embodiments.

Although the magnetic flux 24 from the permanent magnet 22 is high in the region C-C′, the magnetic flux density is low in a portion of the region C-C′ close to the outer circumferential surface of the rotor core, as shown in FIG. 5. Accordingly, forming a recess at such a position barely affects the characteristic of the rotor 7.

Therefore, as shown in FIG. 10, a rotor core 21e of the rotary electric machine according to this embodiment includes a plurality of recesses 25 formed between the permanent magnets 22a, 22b on the outer circumferential surface of the rotor core 21e. Forming thus the recesses 25 allows further reduction in weight and moment of inertia of the rotor 7.

Also, forming the recesses 25 allows the permanent magnets 22 to be attached to the rotor core 21e along the recess 25, thereby facilitating the manufacturing of the rotor 7. Here, the depth of the recess 25 can be adjusted in proportion with the interval between the permanent magnets 22a, 22b.

### Sixth Embodiment

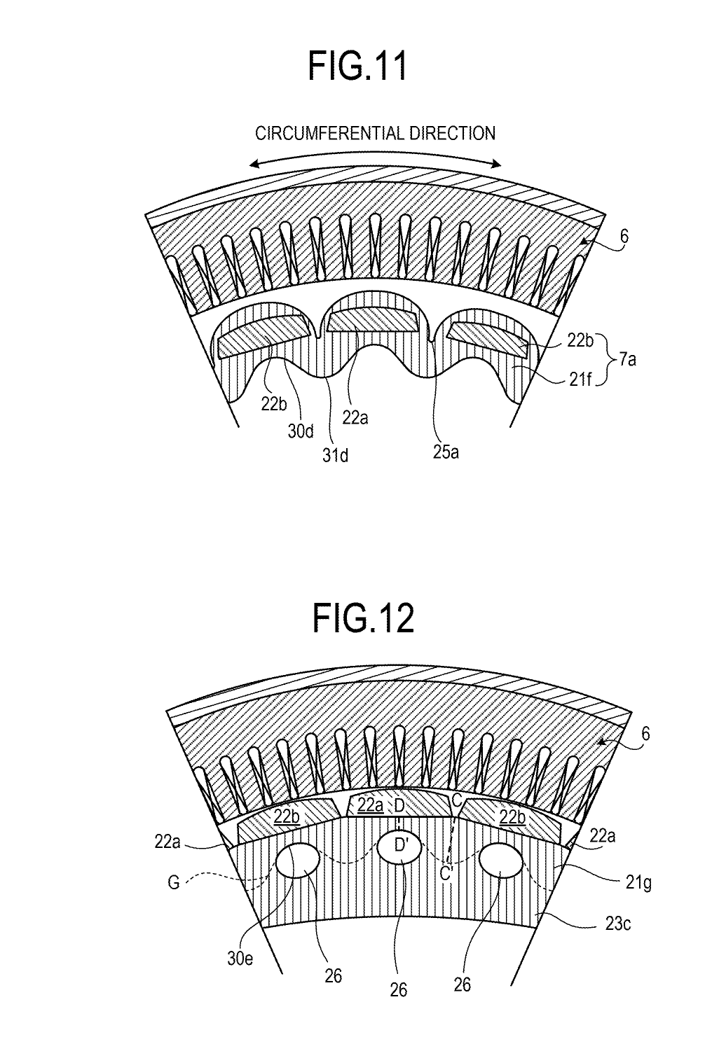

Referring now to FIG. 11, a configuration of a rotary electric machine according to a sixth embodiment will be described. FIG. 11 is an enlarged fragmentary transverse cross-sectional view of the rotary electric machine according to the sixth embodiment. The rotary electric machine according to this embodiment has the same configuration as the rotary electric machine according to the fourth embodiment, except that a plurality of permanent magnets are embedded in a rotor core and that the rotor core includes a plurality of recesses on the outer circumferential surface thereof.

As shown in FIG. 11, in the rotary electric machine according to this embodiment the plurality of permanent magnets 22a, 22b are embedded in a rotor core 21f. A portion of the rotor core 21f radially inner than the permanent magnets 22a, 22b is formed in the same shape as the rotor core 21d shown in FIG. 9.

More specifically, the inner circumferential surface of the rotor core 21f includes, as shown in FIG. 11, a first portion 30d formed at positions corresponding to the central portion of the respective permanent magnets 22 in the circumferential direction, the first portion 30d being recessed with respect to a second portion 31d corresponding to the boundary between the circumferentially adjacent permanent magnets 22.

Such a configuration makes the portion of the rotor core 21f radially inner than the permanent magnets 22a, 22b partially thinner, which leads to a reduction in weight of the rotor 7. Further, the reduction in weight of the rotor core 21f results in a reduced moment of inertia of the rotor 7.

Further, the rotor core 21f includes a plurality of recesses 25a formed between the permanent magnets 22a, 22b on the outer circumferential surface of the rotor core 21f, as the rotor core 21e shown in FIG. 10, which leads to a further weight reduction of the rotor core 21f. Here, the depth of the recess 25a can be adjusted in proportion with the interval between the permanent magnets 22a, 22b. In the rotor core 21f, the portion thereof radially inner than the permanent magnets 22a, 22b may be formed in the same shape as the rotor core according to the first to the third embodiments. Also, the rotor core 21f may be formed without the recess 25a.

### Seventh Embodiment

Referring now to FIG. 12, a configuration of a rotary electric machine according to a seventh embodiment will be described. FIG. 12 is an enlarged fragmentary transverse cross-sectional view of the rotary electric machine according to the seventh embodiment. Here, FIG. 12 corresponds to a transverse cross-sectional view taken along a line E-E′ in FIG. 2. The support brackets 23a to 23d according to this embodiment have the same configuration as those of the first embodiment, except for including a plurality of openings 26.

While the rotary electric machines according to the first to the sixth embodiments are intended for reducing the weight of the rotor core, the rotary electric machine according to this embodiment is intended for reducing the weight of the support brackets 23a to 23d, in addition to the weight of the rotor core.

Specifically, a plurality of openings are formed in each of the support brackets 23a to 23d, so as to penetrate therethrough in a longitudinal direction of the shaft 5. Such a configuration achieves a weight reduction corresponding to the openings, thereby achieving further reduction in weight and moment of inertia of the rotor 7.

For example, as shown in FIG. 12, the support bracket 23c may include column-shaped openings 26 formed penetrating therethrough in the longitudinal direction of the shaft 5, at positions corresponding to a respective first portion 30e of a rotor core 21g. Although not shown, the support brackets 23a, 23b, and 23d may also include such openings 26. The respective support brackets 23a to 23d are integrally formed with the rotor core, as the cross-section taken along the line E-E′. In FIG. 12, broken lines G indicate a boundary between the inner circumferential portion of the rotor core and the support bracket 23c.

Since the magnetic flux 24 from the permanent magnet 22 is barely affected by the first portion 30e of the rotor core 21g, forming the openings 26 barely affects the characteristic of the rotor 7. Therefore, the position corresponding to the first portion 30e is suitable for forming the opening 26.

Forming the openings 26 in a column shape prevents stress concentration at a particular portion of the openings 26, thereby preventing degradation in mechanical strength of the support brackets 23a to 23d.

In the rotor 7 without the openings 26, regions Ja to Jc partioned by the support brackets 23a to 23d each form a closed space as shown in FIG. 2. However, forming the openings 26 turns the regions Ja to Jc into a continuous open space. Such a configuration allows the rotor core 21g to be cooled by air introduced through the openings 26.

Further, the rotor core 21g is thinnest at the region D-D′, and hence the central portion of the permanent magnet 22, which is prone to suffer a high temperature, can be efficiently cooled. Accordingly, forming the openings 26 allows the rotor core 21g, a temperature increase of which affects the characteristic of the rotary electric machine, to be cooled thereby suppressing fluctuation of the characteristic of the rotary electric machine.

It is preferable to determine the size and the number of the openings 26 taking the mechanical strength of the rotor core 21g into account.

As described thus far, the rotor core of the rotary electric machine according to the foregoing embodiments allows reduction in weight of the rotor, thereby achieving weight reduction of the rotary electric machine. Further, since moment of inertia can also be reduced, the characteristic of the rotary electric machine can be improved. Although the shape of the rotor core and that of the support brackets have been described with reference to the respective embodiments, such shapes may be combined as desired.

Obviously, numerous modifications and variations of the present invention are possible in light of the above teachings. It is therefore to be understood that within the scope of the appended claims, the invention may be practiced otherwise than as specifically described herein.

What is claimed as new and is desired to be secured by Letters Patent of the United States is:

1. A rotor for a rotary electric machine comprising:
a cylindrical-shaped rotor core; and
a plurality of permanent magnets aligned in a circumferential direction of the rotor core;
a portion of an inner circumferential surface of the rotor core corresponding to a central portion of the permanent magnet in the circumferential direction is recessed with respect to a portion of the inner circumferential surface corresponding to a boundary between circumferentially adjacent ones of the permanent magnets.

2. The rotor for a rotary electric machine according to claim 1,
wherein in a portion of the rotor core radially inner than the permanent magnet, a thickness of the rotor core between the central portion of the permanent magnet in the circumferential direction and the inner circumferential surface is in a range of 20% to 80% of a thickness between the boundary between the permanent magnets and the inner circumferential surface.

3. The rotor for a rotary electric machine according to claim 1,
wherein the inner circumferential surface of the rotor core has an arcuate shape from the portion corresponding to the central portion of the permanent magnet in the circumferential direction to the portion corresponding to the boundary between the circumferentially adjacent permanent magnets.

4. The rotor for a rotary electric machine according to claim 1,
wherein the rotor core includes a recess formed on an outer circumferential surface thereof at a position corresponding to the boundary between the circumferentially adjacent permanent magnets.

5. The rotor for a rotary electric machine according to claim 1, further comprising:
a plurality of ring-shaped support brackets that support the rotor core and fix the rotor core to a shaft;
wherein the support brackets each include an opening penetrating therethrough in a longitudinal direction of the shaft.

6. A rotary electric machine comprising:
a rotor including a cylindrical-shaped rotor core and a plurality of permanent magnets aligned in a circumferential direction of the rotor core; and
a stator disposed so as to oppose an outer circumferential surface of the rotor with a gap therebetween,
a portion of an inner circumferential surface of the rotor core corresponding to a central portion of the permanent magnet in the circumferential direction is recessed with respect to a portion of the inner circumferential surface of the rotor core corresponding to a boundary between circumferentially adjacent ones of the permanent magnets.
